(19) United States
(12) Patent Application Publication
(10) Pub. No.: US 2012/0120000 A1
(43) Pub. Date: May 17, 2012

(54) METHOD OF INTERACTING WITH A PORTABLE ELECTRONIC DEVICE

(75) Inventors: Drazen Lucic, Toronto (CA); Paul Robin Keip, Kitchener (CA)

(73) Assignee: RESEARCH IN MOTION LIMITED, Waterloo (CA)

(21) Appl. No.: 12/945,161

(22) Filed: Nov. 12, 2010

(51) Int. Cl. G06F 3/041

(52) U.S. Cl. 345/173

(57) ABSTRACT

The present disclosure provides a method of interacting with a portable electronic device and a portable electronic device configured to perform the same. In accordance with one embodiment, the method comprises: detecting motion of the portable electronic device; determining whether detected motion matches a first motion gesture or a second motion gesture; when the first motion gesture is detected, showing a designated user interface element in a user interface screen displayed on a touch-sensitive display of the portable electronic device; and when the second motion gesture is detected, hiding the designated user interface element from the user interface screen displayed on the touch-sensitive display of the portable electronic device.

### TECHNICAL FIELD

The present disclosure relates to portable electronic devices, including but not limited to portable electronic devices having touch screen displays and their control.

### BACKGROUND

Electronic devices, including portable electronic devices, have gained widespread use and may provide a variety of functions including, for example, telephonic, electronic messaging and other personal information manager (PIM) application functions. Portable electronic devices include, for example, several types of mobile stations such as simple cellular telephones, smart telephones, wireless personal digital assistants (PDAs), and laptop computers with wireless 802.11 or Bluetooth™ capabilities.

Portable electronic devices such as PDAs or smart telephones are generally intended for handheld use and ease of portability. Smaller devices are generally desirable for portability. A touch-sensitive display, also known as a touchscreen display, is particularly useful on handheld devices, which are small and have limited space for user input and output. As new functions and capabilities are added to portable electronic devices, the number of onscreen elements provided by such devices increases. Accordingly, improvements in controlling portable electronic devices which accommodate the demand for screen space on touch-sensitive displays are desirable.

### BRIEF DESCRIPTION OF THE DRAWINGS

FIG. 1 is a simplified block diagram of components including internal components of a portable electronic device to which embodiments of the current disclosure may be applied;

FIG. 2 is a perspective view of an example of a portable electronic device to which embodiments of the current disclosure may be applied;

FIGS. 3A and 3B are front views of a portable electronic device illustrating example user interface screens with which embodiments of present disclosure may be applied;

FIG. 4 is a front view of the portable electronic device of FIGS. 3A and 3B with a direction of movement shown by a block arrow with corresponding acceleration-time graphs for the movement;

FIG. 5A is a front view of the portable electronic device of FIGS. 3A and 3B with a direction of an upward flick gesture shown by a block arrow;

FIG. 5B is a front view of the portable electronic device of FIGS. 3A and 3B with a direction of a downward flick gesture shown by a block arrow;

FIG. 5C is a front view of the portable electronic device of FIGS. 3A and 3B with a direction of a toss movement shown by a block arrow with corresponding acceleration-time graphs for the movement;

FIG. 5D is a front view of the portable electronic device of FIGS. 3A and 3B with a direction of a left-right cycle gesture shown by a block arrow;

FIG. 5E is a front view of the portable electronic device of FIGS. 3A and 3B with a direction of a right-left cycle gesture shown by a block arrow;

FIG. 5F is an acceleration-time graph for a pair of shake gestures of the portable electronic device of FIG. 3A;

FIG. 5G is an acceleration-time graph for a repeated shaking gesture of the portable electronic device of FIG. 3A along the x-axis;

FIG. 6 is a flowchart illustrating a method of interacting with a portable electronic device using a touch-sensitive display in accordance with one example embodiment of the present disclosure;

FIG. 7 is a flowchart illustrating a method of interacting with a portable electronic device using a touch-sensitive display in accordance with another example embodiment of the present disclosure; and

FIG. 8 is a flowchart illustrating a method of interacting with a portable electronic device using a touch-sensitive display in accordance with a further example embodiment of the present disclosure.

### DETAILED DESCRIPTION OF EXAMPLE EMBODIMENTS

The present disclosure provides methods of interacting with a portable mobile device using designated, motion gestures to control the content displayed on a touch-sensitive display, to control actions performed by the portable mobile device, or both. In one example, a pair of opposite motion gestures is used to show and hide a designated user interface element such as a virtual keyboard in a user interface screen displayed on the touch-sensitive display, thereby obviating the need to press a mechanical key or touch the touch-sensitive display to show or hide the designated user interface element.

In accordance with one embodiment of the present disclosure, there is provided a method of interacting with a portable electronic device, the method comprising: detecting motion of the portable electronic device; determining whether detected motion matches a first motion gesture or a second motion gesture; when the first motion gesture is detected, showing a designated user interface element in a user interface screen displayed on a touch-sensitive display of the portable electronic device; and when the second motion gesture is detected, hiding the designated user interface element from the user interface screen displayed on the touch-sensitive display of the portable electronic device.

In accordance with another embodiment of the present disclosure, there is provided a method of interacting with a portable electronic device, the method comprising: detecting motion of the portable electronic device; determining whether detected motion matches a first motion gesture or a second motion gesture; when the first motion gesture is detected, showing a designated user interface element in a user interface screen displayed on a touch-sensitive display of the portable electronic device; and when the second motion gesture is detected, showing a second designated user interface element in a user interface screen displayed on the touch-sensitive display of the portable electronic device.

In accordance with a further embodiment of the present disclosure, there is provided a method of interacting with a portable electronic device, the method comprising: detecting motion of the portable electronic device; determining whether detected motion matches known motion gestures; when a toss gesture is detected, sending an electronic message under composition to at least one address specified by the electronic message under composition; when a left-right gesture is detected, displaying a next electronic message in an inbox or message list of an electronic messaging application; and when a right-left gesture is detected, displaying a previous electronic message in an inbox or message list of the electronic messaging application.

In accordance with a further embodiment of the present disclosure, there is provided a method of interacting with a portable electronic device, the method comprising: detecting motion of the portable electronic device; determining whether detected motion matches known motion gestures; when a toss gesture is detected, sending a data object to a second electronic device using a short-range communication protocol; when a left-right gesture is detected, reproducing content of a next data object in a datastore of a media player application; and when a right-left gesture is detected, reproducing content of a previous next data object in a datastore of a media player application.

In accordance with a further embodiment of the present disclosure, there is provided a portable electronic device, comprising: a housing; a processor received within the housing; a touch-sensitive display coupled to the processor and having a touch-sensitive overlay exposed by the housing; and an accelerometer coupled to the processor, wherein the processor is configured to perform the methods described herein.

In accordance with a further embodiment of the present disclosure, there is provided a portable electronic device, comprising: a housing; a processor received within the housing; a touch-sensitive display coupled to the processor and having a touch-sensitive overlay exposed by the housing; and an accelerometer coupled to the processor; wherein the processor is configured for: detecting motion of the portable electronic device; determining whether detected motion matches a first motion gesture or second motion gesture; when the first motion gesture is detected, causing a designated user interface element to be shown in a user interface screen displayed on a touch-sensitive display of the portable electronic device; and when the second motion gesture is detected, causing the designated user interface element to be hidden from the user interface screen displayed on the touch-sensitive display of the portable electronic device.

The present disclosure generally relates to portable electronic devices which may be carried in a user's hands (i.e., handheld electronic devices). Examples of portable electronic devices include, but are not limited to, pagers, mobile phones, smartphones, wireless organizers, PDAs, portable media players, portable gaming devices, Global Positioning System (GPS) navigation devices, electronic book readers, cameras, and notebook and tablet computers. Embodiments of the present disclosure may be applied to other portable electronic devices not specifically described in the above examples.

Reference will now be made to the accompanying drawings which show, by way of example, embodiments of the present disclosure. For simplicity and clarity of illustration, reference numerals may be repeated among the Figures to indicate corresponding or analogous elements. Numerous details are set forth to provide an understanding of the embodiments described herein. The embodiments may be practiced without these details. In other instances, well-known methods, procedures, and components have not been described in detail to avoid obscuring the embodiments described. The description is not to be considered as limited to the scope of the embodiments described herein.

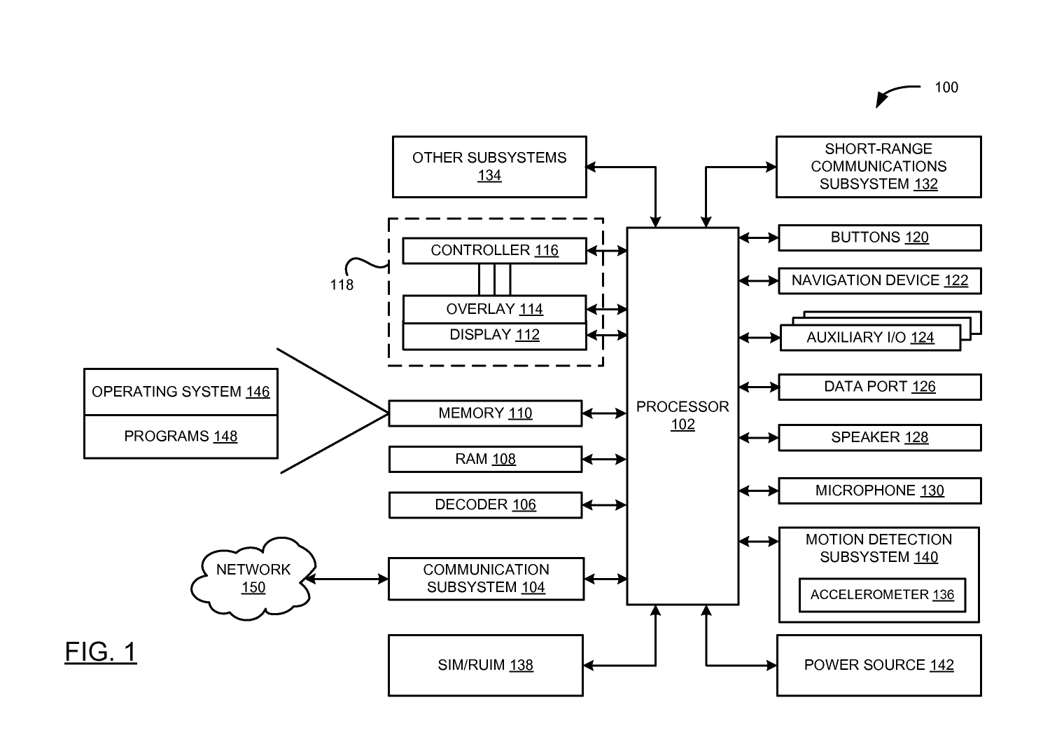

Reference is made to FIG. 1, which illustrates in block diagram form, a portable electronic device 100 to which example embodiments described in the present disclosure can be applied. The portable electronic device 100 includes multiple components, such as a processor 102 that controls the overall operation of the portable electronic device 100. Communication functions, including data and voice communications, are performed through a communication subsystem 104. Data received by the portable electronic device 100 is decompressed and decrypted by a decoder 106. The communication subsystem 104 receives messages from and sends messages to a wireless network 150. The wireless network 150 may be any type of wireless network, including, but not limited to, data wireless networks, voice wireless networks, and networks that support both voice and data communications. A power source 142, such as one or more rechargeable batteries or a port to an external power supply, powers the portable electronic device 100.

The processor 102 interacts with other components, such as Random Access Memory (RAM) 108, memory 110, a display 112 (such as a liquid crystal display (LCD)) with a touch-sensitive overlay 114 coupled to an electronic controller 116 that together comprise a touch-sensitive display 118, one or keys or buttons 120, a navigation device 122, one or more auxiliary input/output (I/O) subsystems 124, a data port 126, a speaker 128, a microphone 130, short-range communications subsystem 132, and other device subsystems 134. It will be appreciated that the electronic controller 116 of the touch-sensitive display 118 need not be physically integrated with the touch-sensitive overlay 114 and display 112. User-interaction with a graphical user interface (GUI) is performed through the touch-sensitive overlay 114. The GUI displays user interface screens on the touch-sensitive display 118 for displaying information or providing a touch-sensitive onscreen user interface element for receiving input. This content of the user interface screen varies depending on the device state and active application, among other factors. Some user interface screens may include a text field sometimes called a text input field. The processor 102 interacts with the touch-sensitive overlay 114 via the electronic controller 116. Information, such as text, characters, symbols, images, icons, and other items that may be displayed or rendered on a portable electronic device, is displayed on the touch-sensitive display 118 via the processor 102.

The portable electronic device 100 also comprises a motion detection subsystem 140 comprising at least one sensor which is coupled to the processor 102 and which is controlled by one or a combination of a monitoring circuit and operating software. The sensor has a sensing element which detects acceleration from motion and/or gravity. The sensor generates and outputs an electrical signal representative of the detected acceleration. Changes in movement of the portable electronic device 100 results in changes in acceleration which produce corresponding changes in the electrical signal output of the sensor. In at least some embodiments, the sensor is an accelerometer 136 such as a three-axis accelerometer having three mutual orthogonally sensing axes. The accelerometer 136 detects changes in the acceleration of the portable electronic device 100. Other types of motion sensors may be used by the motion detection subsystem 140 in addition to, or instead of, the accelerometer 136 in other embodiments. The other motion sensors may comprise a proximity sensor, gyroscope, or both, which detect changes in the proximity and orientation of portable electronic device 100.

Changes in acceleration, proximity and orientation detected by the accelerometer 136, proximity sensor and/or gyroscope may be interpreted by the portable electronic device 100 as motion of the portable electronic device 100. When the changes in acceleration, proximity and orientation are within threshold tolerance(s) of regularity or predictability, when the changes in acceleration, proximity and orientation match predetermined motion criteria (e.g., stored in the memory 110), the changes may be interpreted by the portable electronic device 100 as a pattern of motion. Multiple patterns of motion may be recognized by the portable electronic device 100.

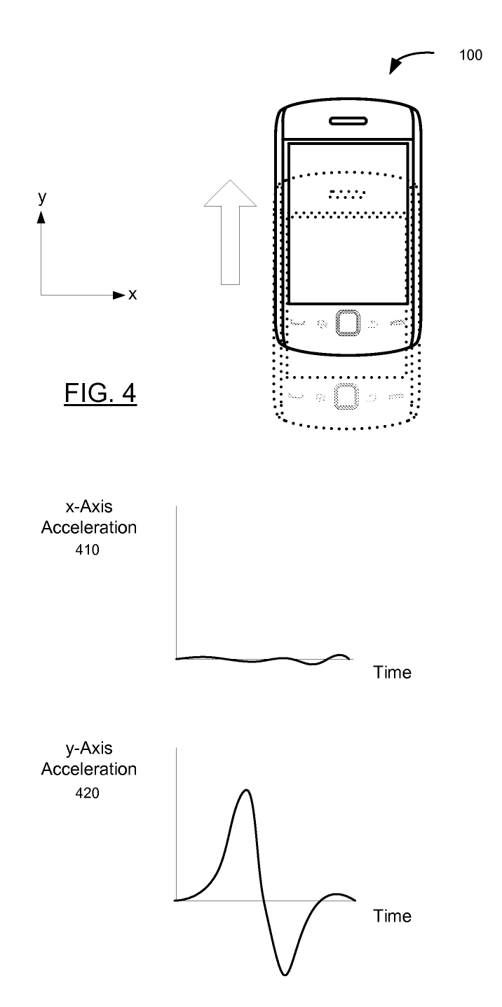

Referring to FIG. 4, an example accelerometer response to a movement of the portable electronic device 100 in the y-direction from rest followed by a stopping of the movement will be shown. The direction of movement is shown by a block arrow. Corresponding acceleration-time graphs for the movement illustrate example acceleration signals which may be generated by the accelerometer 136 (or motion detection subsystem 140) in response to the movement (or motion sequence). For this motion sequence, the acceleration in the x-direction 410 sensed by the accelerometer 136 stays fairly constant at approximately zero (0) G, while the acceleration in the y-direction 420 increases as the portable electronic device 100 starts moving, and then turns negative as the device is brought to a stop. The motion pattern in the signal will be affected by the speed and force with which a user performs a particular motion sequence.

By configuring the processor 102 to recognize certain motion patterns in the acceleration signal from the accelerometer 136, the processor 102 can determine whether the portable electronic device 100 has been moved in a certain motion sequence. Predetermined motion sequences recognized by the processor 102 in accordance with a designated pattern of motion will herein be referred to as motion gestures. Motion gestures performed by the user may cause acceleration in one or more sensing axes and in one or more directions.

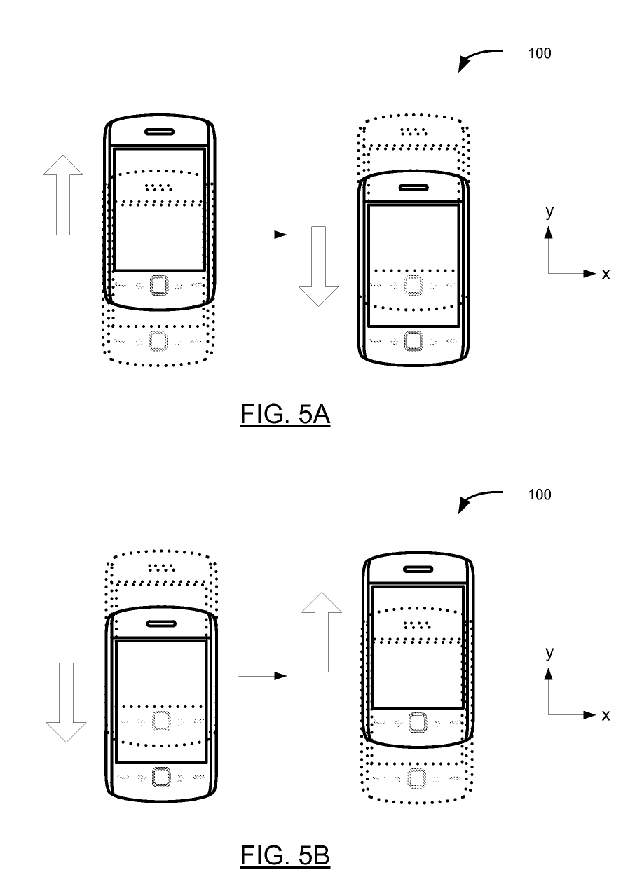

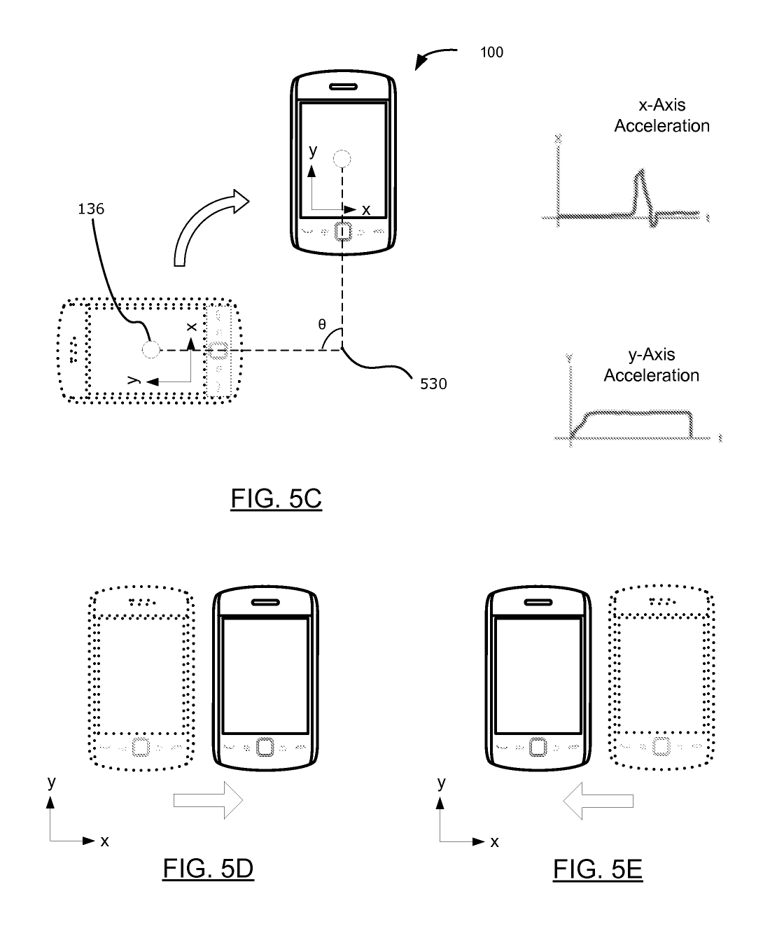

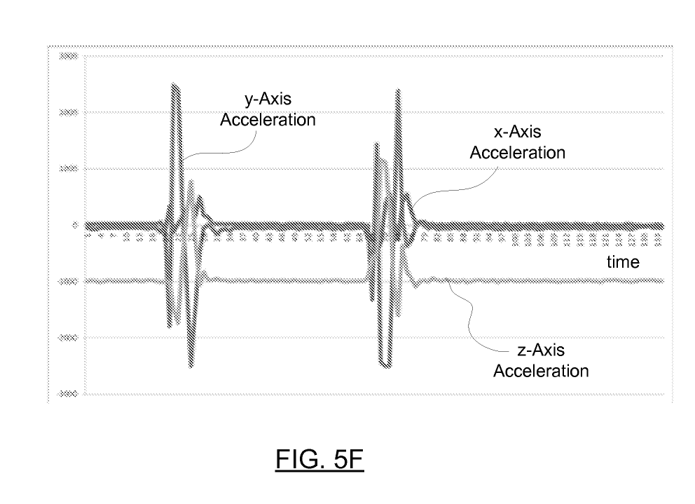

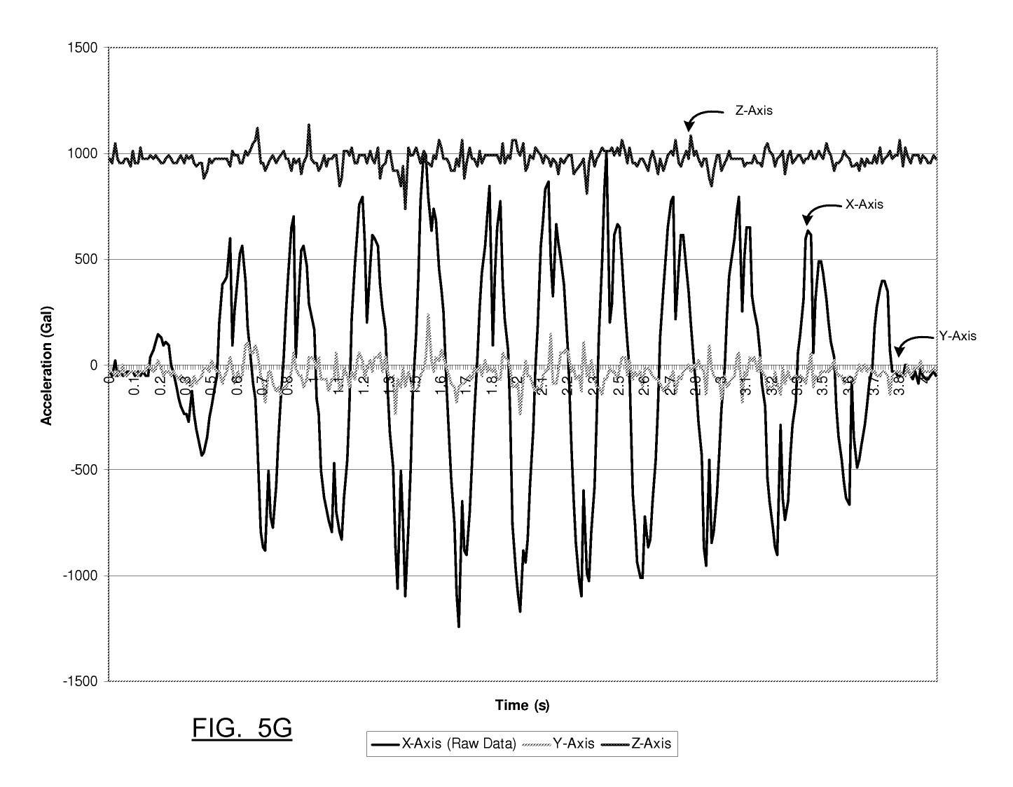

FIGS. 5A to 5E illustrate, by way of example, a number of motion gestures which may be detected by the portable electronic device 100. FIG. 5A shows a first flick gesture in which the portable electronic device 100 is moved in the positive y-direction and then back in the negative y-direction. FIG. 5B shows a second flick gesture in which the portable electronic device 100 is moved in the negative y-direction and then in the positive y-direction. The second flick gesture is reverse flick gesture which is a reversed motion sequence of the first flick gesture.

FIG. 5C shows a toss gesture in which the portable electronic device 100 is rotated clockwise about an axis of rotation 530. The toss gesture is similar to the motion used to throw a flying disc such as a Frisbee®. The angle of rotation θ and distance between the accelerometer 136 and the axis of rotation 530 may affect the acceleration signal generated. In some embodiments, a toss gesture can be based on the acceleration signals generated when the angle of rotation 8 is around 90 degrees, and the distance between the accelerometer 136 and the axis of rotation can be estimated by assuming the axis of rotation is located about the wrist joint of an average user. In other embodiments, the processor 102 can be configured to recognize a toss gesture to have occurred based on the acceleration signals generated for any predetermined angle of rotation θ, direction of rotation, or axis of rotation 530.

The toss gesture shown in FIG. 5C is sometimes referred to as a toss “away” gesture since the gesture starts with the portable electronic device 100 held towards the user and moves away from the user. A toss “towards” gesture is related, but opposite to, a toss “away” gesture. The toss “towards” gesture starts with the portable electronic device 100 held away from the user and moves towards from the user. The acceleration-time graph for a toss “towards” gesture would be similar to the acceleration-time graph for a toss “away” gesture with the curve for the x-axis inverted and the curve for the y-axis the same.

FIG. 5D shows a left-right cycle gesture wherein the portable electronic device 100 is moved from left to right in the positive x-direction. FIG. 5E shows a right-left cycle gesture wherein the portable electronic device 100 is moved from right to left in the negative x-direction.

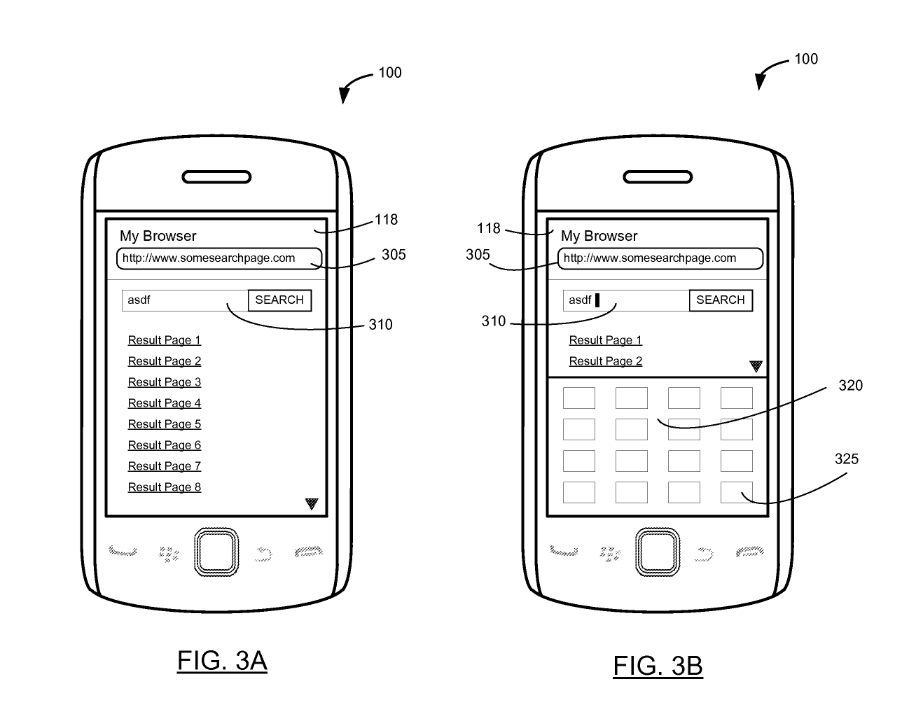

FIG. 5F shows an acceleration-time graph for a pair of shake gestures which may be detected by the portable electronic device 100. FIG. 5G shows an acceleration-time graph for a repeated shaking gesture of the portable electronic device of FIG. 3A along the x-axis. The acceleration in FIGS. 5F and 5G is shown in Gal over a time duration measured in seconds using each of the three sensing axes (i.e., x, y and z axes) of a three-axis accelerometer. The z-axis in FIG. 5F is calibrated for a steady-state reading of −1 g (−1000 Gal) whereas the z-axis in FIG. 5G is calibrated for a steady-state reading of +1 g (1000 Gal), otherwise the acceleration-time graphs are comparable in terms of device characteristics.

The shaking shown in FIG. 5G is characterized by alternating increase and decreases in acceleration. At the start of the acceleration the portable electronic device 100 was substantially still representing a period of relative stability. Because the acceleration of FIG. 5G represents a lateral shaking motion of the portable electronic device 100 along the x-axis, the acceleration from the y-axis and z-axis is relatively stable. The acceleration also illustrates that the z-axis was substantially parallel to gravity during the shaking movement as it experiences a force of acceleration of approximately 980 Gal (9.8 m/s²).

The shaking movement illustrated in FIG. 5G is characterized by acceleration on the x-axis which alternates between positive acceleration spikes and negative acceleration spikes. In the positive acceleration spikes, the accelerometer acceleration along the x-axis increases from a general baseline measurement in the stable period prior to the shaking movement. Similarly, in the negative acceleration (e.g. deceleration) spikes, the acceleration along the x-axis decreases from the baseline in the stable period prior to the shaking movement. In the example shown, prior to and during the shaking movement, the x-axis is generally perpendicular to the earth's gravitational force. In this orientation, the acceleration on the x-axis is approximately zero Gal when the portable electronic device 100 is not since force of gravity acting on the y and z axes in this position is approximately zero. Accordingly, in the shown example shown, the positive acceleration periods may be defined as the periods in which the accelerometer acceleration on the x-axis is greater than the baseline when the device 100 was not moving, and the negative acceleration periods may be defined as the periods in which the acceleration on the x-axis is less than baseline when the device 100 was not moving.

The motion gestures described above have been described by way of example and not intended to be limiting unless explicitly stated otherwise herein. The processor 102 may be configured to determine when any motion gesture. In some embodiments, the portable electronic device 100 may provide a gesture defining mode which allows users to configure the processor 102 to recognize a user defined gestures. In the gesture defining mode, a user may perform a gesture a predetermined number of times. The processor 102 then stores the associated motion patterns and/or predetermined motion criteria in memory 110 for detecting the user defined gestures. The motion patterns and/or predetermined motion criteria may then be mapped to user interface changes and/or commands or actions performed by the portable electronic device 100, for example, using a configuration menu provided in the gesture defining mode. When the user interface changes and/or commands or actions are supported by the active application 148 or operating system 146 in a device state, performing the user defined gestures will cause the portable electronic device 100 to perform the user interface changes and/or commands or actions associated (e.g., mapped) to those user defined gestures.

As will also be appreciated by persons skilled in the art, accelerometers may produce digital or analog output signals. Generally, two types of outputs are available depending on whether an analog or digital accelerometer is used: (1) an analog output requiring buffering and analog-to-digital (A/D) conversion; and (2) a digital output which is typically available in an industry standard interface such as an SPI (Serial Peripheral Interface) or I2C (Inter-Integrated Circuit) interface. When the accelerometer is analog, the memory 110 includes machine-readable instructions for calculating acceleration based on electrical output input from the accelerometer 136. The processor 102 executes the machine-readable instructions to calculate acceleration which may be used by the operating system 146 and/or applications 148 as input. Depending on the acceleration input, the operating system 146 and/or applications 148 may perform operations causing changes to the state of the portable electronic device 100, including but not limited to a change in the operational state or a change in the content displayed on the display screen 112.

The output of the accelerometer 136 is typically measured in terms of the gravitational acceleration constant at the Earth's surface, denoted g, which is approximately 9.81 m/s² (32.2 ft/s²) as the standard average, or in terms of units Gal (cm/s²). The accelerometer 136 may be of almost any type including, but not limited to, a capacitive, piezoelectric, piezoresistive, or gas-based accelerometer. The range of accelerometers vary up to the thousands of g's, however for portable electronic devices “low-g” accelerometers may be used. Example low-g accelerometers which may be used are MEMS digital accelerometers from Analog Devices, Inc. (ADI), Freescale Semiconductor, Inc. (Freescale) and STMicroelectronics N.V. of Geneva, Switzerland. Example low-g MEMS accelerometers are model LIS331DL, LIS3021DL and LIS3344AL accelerometers from STMicroelectronics N.V. The LIS3344AL model is an analog accelerometer with an output data rate of up to 2 kHz which has been shown to have good response characteristics in analog sensor based motion detection subsystems.

The auxiliary I/O subsystems 124 could include other input devices such as one or more control keys, a keyboard or keypad, navigational tool (input device), or both. The navigational tool may be a depressible (or clickable) joystick such as a depressible optical joystick, a depressible trackball, a depressible scroll wheel, or a depressible touch-sensitive trackpad or touchpad. The other input devices could be included in addition to, or instead of, the touch-sensitive display 118, depending on the embodiment.

To identify a subscriber for network access, the portable electronic device 100 uses a Subscriber Identity Module or a Removable User Identity Module (SIM/RUIM) card 138 for communication with a network, such as the wireless network 150. Alternatively, user identification information may be programmed into memory 110.

The portable electronic device 100 includes an operating system 146 and software programs or components 148 that are executed by the processor 102 and are typically stored in a persistent, updatable store such as the memory 110. Additional applications or programs may be loaded onto the portable electronic device 100 through the wireless network 150, the auxiliary I/O subsystem 124, the data port 126, the short-range communications subsystem 132, or any other suitable subsystem 134.

A received signal such as a text message, an e-mail message, or web page download is processed by the communication subsystem 104 and input to the processor 102. The processor 102 processes the received signal for output to the display 112 and/or to the auxiliary I/O subsystem 124. A subscriber may generate data items, for example e-mail messages, which may be transmitted over the wireless network 150 through the communication subsystem 104. For voice communications, the overall operation of the portable electronic device 100 is similar. The speaker 128 outputs audible information converted from electrical signals, and the microphone 130 converts audible information into electrical signals for processing.

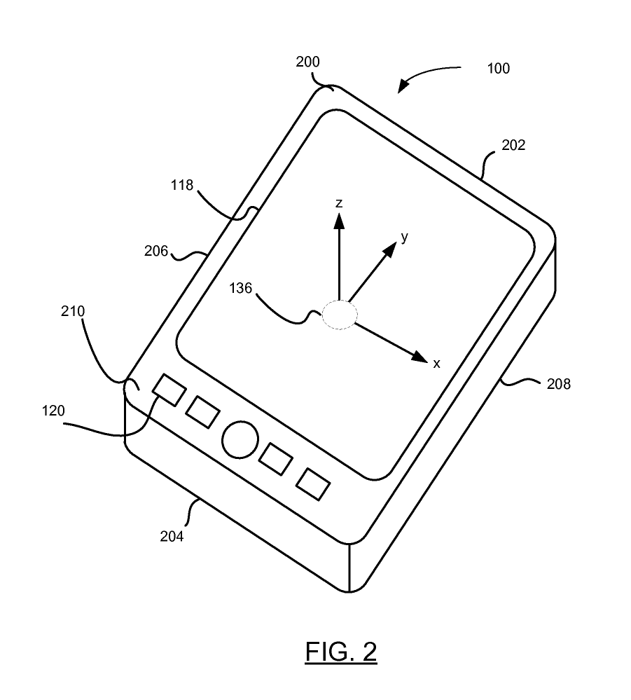

FIG. 2 shows a front perspective view of an example of a portable electronic device 100. The portable electronic device 100 includes a housing 200 that houses internal components including internal components shown in FIG. 1. In the embodiment shown in FIG. 1, the housing 200 is elongate having a length greater than its width. The housing 200 has opposed top and bottom ends designated by references 202, 204 respectively, and two left and right sides extending transverse to the top and bottom ends 202, 204, designated by references 206, 208 respectively. Although the housing 200 is shown as a single unit, it could, among other possible configurations, include two or more case members hinged together (such as, for example, a flip-phone configuration or a clam shell-style laptop computer). Other device configurations are also possible.

The housing 200 also frames the touch-sensitive display 118 such that the touch-sensitive display 118 is exposed for user-interaction therewith when the portable electronic device 100 is in use. It will be appreciated that the touch-sensitive display 118 may include any suitable number of user-selectable features rendered thereon, for example, in the form of virtual buttons for user-selection of, for example, applications, options, or keys of a keyboard for user entry of data during operation of the portable electronic device 100.

The touch-sensitive display 118 may be any suitable touch-sensitive display, such as a capacitive, resistive, infrared, surface acoustic wave (SAW) touch-sensitive display, strain gauge, optical imaging, dispersive signal technology, acoustic pulse recognition, and so forth, as known in the art. A capacitive touch-sensitive display includes a capacitive touch-sensitive overlay 114. The overlay 114 may be an assembly of multiple layers in a stack including, for example, a substrate, a ground shield layer, a barrier layer, one or more capacitive touch sensor layers separated by a substrate or other barrier, and a cover. The capacitive touch sensor layers may be any suitable material, such as patterned indium tin oxide (ITO).

The buttons 120 may be separately operable buttons or may be located below the touch-sensitive display 118 on a front face 210 of the portable electronic device 100. The buttons 120 generate corresponding input signals when activated. The buttons 120 may be constructed using any suitable button (or key) construction such as, for example, a dome-switch construction. The actions performed by the portable electric device 100 in response to activation of respective buttons 120 are context-sensitive. The action performed depends on a context that the button was activated. The context may be, but is not limited to, a device state, application, screen context, selected item or function, or any combination thereof.

Referring now to FIG. 2, an accelerometer 136 is shown located within portable electronic device 100. The accelerometer 136 includes three mutual orthogonally sensing axes denoted x, y and z which are aligned with the form factor of the portable electronic device 100. In some embodiments, the accelerometer 136 is aligned such that a first sensing axis (e.g., the x-axis) extends longitudinally between left and right sides 206, 208 of the portable electronic device 100, a second sensing axis (e.g., the y-axis) extends laterally between top and bottom ends 202, 204, and a third sensing axis (e.g., the z-axis) extends perpendicularly through the x-y plane defined by the x and y axes at the intersection (origin) of these axes. In such a configuration, when the portable electronic device 100 is oriented horizontally, the x and y axes are parallel to the horizontal axis and the z axis has the force of gravity operating directly upon it. The sensing axes x, y, z could be aligned with different features of the portable electronic device 100 in other embodiments.

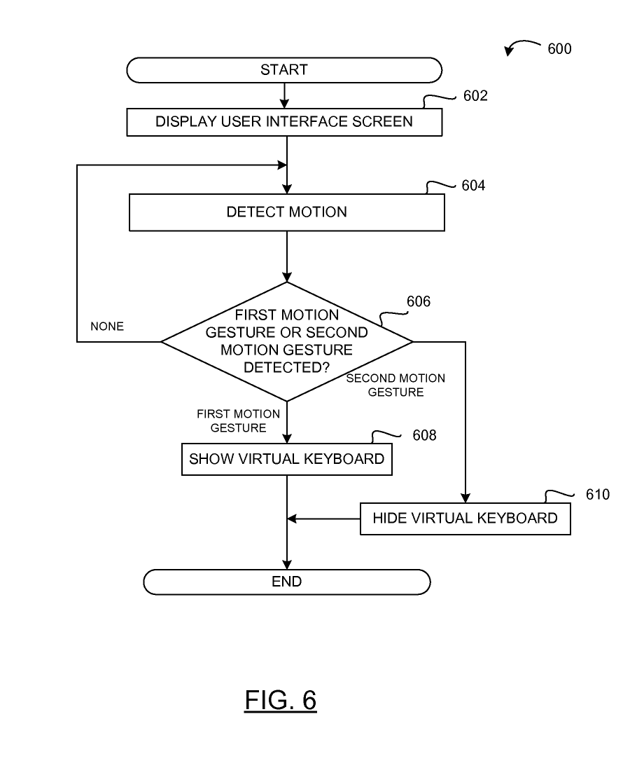

A flowchart illustrating one example embodiment of a method 600 of interacting with a portable electronic device using a touch-sensitive display in accordance with one example embodiment of the present disclosure is shown in FIG. 6. The method 600 may be carried out by software executed, for example, by the processor 102. Coding of software for carrying out such a method 600 is within the scope of a person of ordinary skill in the art provided the present disclosure. The method 600 may contain additional or fewer processes than shown and/or described, and may be performed in a different order. Computer-readable code executable by the processor 102 to perform the method 600 may be stored in a computer-readable medium such as the memory 110.

First, a user interface screen having a text input field for input text is displayed on the touch-sensitive display 118 of the portable electronic device 100 (602). FIGS. 3A and 3B show user interface screens for a Web browser application displayed on the touch-sensitive display 118. In FIG. 3A, a part of a webpage is displayed by the Web browser application. In the shown example, the entire webpage does not fit within the display area of the touch-sensitive display 118 and so a user must scroll down to see the remainder of the webpage.

Next, the portable electronic device 100 monitors for and detects motion of the portable electronic device 100 (604). Motion is typically detected using the motion sensor of the motion detection subsystem 140, such as the accelerometer 136 which uses acceleration measurements to detect motion. The portable electronic device 100 monitors acceleration measurements reported by the accelerometer 136 and detects motion when acceleration matches predetermined criteria. The motion detection subsystem 140 and/or accelerometer 136 may generate an analog or digital acceleration signal in response to motion and acceleration. Similar motions generate similar acceleration signal patterns.

Next, the portable electronic device 100 determines whether detected motion matches a first motion gesture or a second motion gesture (decision block 606) based on patterns of motion recognized by the portable electronic device 100. The second motion gesture is different from the first motion gesture. The portable electronic device 100 has a motion analyzing unit which analyses the acceleration measurements in terms of factors such as amplitude/magnitude over time, frequency, or other factors to determine whether the detected motion matches a known motion gesture such as the first or second motion gesture.

When the first motion gesture is detected, a virtual (or soft) keyboard 320 is shown (e.g., invoked) on the user interface screen displayed on the touch-sensitive display 118 of the portable electronic device 100 (608). The virtual keyboard 320 comprises a number of virtual (or soft) keys 325 as shown in FIG. 3B. Typically, this only occurs when the virtual keyboard 320 is not already displayed on the touch-sensitive display 118. In such embodiments, when the first motion gesture is detected while the virtual keyboard 320 is already displayed, the first motion gesture is ignored. Alternatively, the virtual keyboard 320 may be hidden and re-shown in response to detecting the first motion gesture for GUI effect, or a secondary function may be performed by the portable electronic device 100 such as, for example, character input (e.g., of a special character) or performance of a command or action.

Showing the virtual keyboard 320 on the touch-sensitive display 118 comprises rendering at least the virtual keyboard 320 and displaying the rendered virtual keyboard 320 on the display 112. Showing may comprise rendering the entire user interface screen including the virtual keyboard 320 and displaying the rendered user interface screen on the touch-sensitive display 118. In other embodiments, only the virtual keyboard 320 is rendered and displayed while the remainder of the user interface screen is unchanged and is not rendered for efficient graphics processing on the portable electronic device 100. Showing the virtual keyboard 320 may also comprise configuring processor 102 to recognize touch inputs associated with the virtual keyboard 320, such as touch inputs associated with the keys of the virtual keyboard 320.

When the second motion gesture is detected, the virtual keyboard 320 is hidden in the user interface screen displayed on the touch-sensitive display 118 of the portable electronic device 100 (610). Typically, this occurs when the virtual keyboard 320 is displayed on the touch-sensitive display 118. In such embodiments, when the second motion gesture is detected while the virtual keyboard 320 is already hidden, the second motion gesture is ignored. Alternatively, the virtual keyboard 320 may be shown and re-hidden in response to detecting the second motion gesture for GUI effect, or a secondary function may be performed by the portable electronic device 100 such as, for example, character input (e.g., of a special character) or performance of a command or action.

Hiding the virtual keyboard 320 on the touch-sensitive display 118 comprises rendering a portion of the user interface screen in the location of the virtual keyboard 320 and displaying the portion of the user interface screen to be shown when the virtual keyboard 320 is hidden. Hiding the designated user interface element may comprise rendering the entire user interface screen without the virtual keyboard 320 and displaying the rendered user interface screen on the touch-sensitive display 118. In other embodiments, only the portion of the user interface screen used by the virtual keyboard 320 is rendered and displayed while the remainder of the user interface screen is unchanged and is not rendered for efficient graphics processing on the portable electronic device 100.

When the detected motion does not match the first motion gesture or second motion gesture, the motion is ignored. Alternatively, if the detected motion matches another motion gesture recognized by the portable electronic device 100, the command or action associated with that other motion gesture may be performed, depending on the embodiment.

The availability of the virtual keyboard 320 for invocation may depend on the presence of a text input field for input text such as an address bar 305 or search bar 310. Typically, the availability of the virtual keyboard 320 for invocation depends on a text input field being active. The text input field may be made an active field by appropriate input including, for example, selection of the text input field using an onscreen position indicator. Selection with the key 325 with the onscreen position indicator may involve highlighting or focusing the text input field. Selecting the text input field may cause the appearance of the text input field to be changed from a first visual state to a second visual state different from the first visual state. Changing the appearance of the text input field may cause the colour to change from an initial colour (e.g. white or grey) to a different colour (e.g., blue).

The virtual keyboard 320 may be a full QWERTY keyboard or a reduced QWERTY keyboard. Each key 325 in the virtual keyboard 320 may be associated with one or more indicia representing an alphabetic character, a numeral character or a command (such as a space command, return command, or the like). The plurality of the keys having alphabetic characters may be arranged in a standard keyboard layout such as a QWERTY layout, a QZERTY layout, a QWERTZ layout, an AZERTY layout, a Dvorak layout, a Russian keyboard layout, a Chinese keyboard layout, or other suitable layout. These standard layouts are provided by way of example and other similar standard layouts may be used. The keyboard layout may be based on the geographical region in which the portable electronic device 100 is intended for use. Touching a key 325 in the virtual keyboard 320 causes a character associated with the key 325 to be input and displayed in a text input field on the touch-sensitive display 118, or causes a command or other input associated with the key 325 to be performed by the portable electronic device 100.

Touching a key 325 comprises touching a location of the touch-sensitive display 118 which is coincident with the key 325 on the display 112. A location is coincident with the key 325 in that the centroid of the touch event is within an input area of the user interface screen assigned for receiving input for activating the key 325. The input area of the key 325 in some embodiments may be different than the displayed area of the key 325 on the display 112, typically the input area being larger than the displayed area in such embodiments to accommodate touch offset of the user.

In at least some embodiments, the first motion gesture and second motion gesture are directional motion gestures having a primary direction of motion, wherein the primary direction of motion of the first motion gesture and second motion are oriented in generally opposite directions to each other. The second motion gesture may be a reversed motion sequence of the first motion gesture. The first motion gesture and second motion gesture may be, in at least some embodiments, flick gestures oriented in generally opposite directions to each other. Typically, the first motion gesture (e.g., first flick motion gesture) comprises a generally up-down motion and the second motion gesture (e.g., second flick motion gesture) comprises a generally down-up motion. This mapping of motion gestures to showing and hiding the virtual keyboard 320 provides a more intuitive solution in that the actions of the user for showing and hiding the virtual keyboard 320 mimic the physical movement required to open a flip phone to expose a physical keypad or keyboard and close the flip phone to conceal the physical keypad or keyboard. The motion gestures are also similar to the physical movement required to open a slider phone to expose a physical keypad or keyboard and close the slider phone to conceal the physical keypad or keyboard.

In other embodiments, the first motion gesture (e.g., first flick motion gesture) may comprise a generally down-up motion and the second motion gesture (e.g., second flick motion gesture) may comprise a generally up-down motion. In yet other embodiments, the first motion gesture and the second motion gesture may be the same.

In other embodiments, the first motion gesture may comprise a left-right cycle gesture and the second motion gesture may comprise a right-left cycle gesture. This combination of motion gestures is an alternative combination of directional motion gestures having reverse or opposite primary direction of motion. This alternative combination of motion gestures could be used instead of a flick gesture and a reverse flick gesture to provide a pair of opposite motion gestures is used to show and hide a different user interface element such as a context-sensitive menu.

The method 600 uses the first and second motion gestures to show and hide the virtual keyboard 320 without the need to press a mechanical key or touch the touch-sensitive display 118 as is conventionally done. When a mechanical key is not needed to show or hide the virtual keyboard 320, the key can be omitted from the portable electronic device 100 reducing costs and simplify device design and construction. When interaction with the touch-sensitive display 118 is not required to show or hide the virtual keyboard 320 (such as swiping or otherwise activating an icon or other onscreen element on a touch-sensitive display 118), accidental activation of touch gesture commands can be avoided. The method 600 also overcomes problems with solution which automatically display a virtual keyboard when a text input field is in active focus. However, this condition is undesired in many circumstances, most notably because it presents the possibility for a user to accidentally select a text input field bringing it into active focus and triggering the portable electronic device 100 to display the virtual keyboard.

While described in the context of the virtual keyboard 320, the method 600 can be applied to a different designated user interface element such as a context-sensitive menu associated with the operating system 146, active application or active onscreen element. The context-sensitive menu provides a limited set of commands or actions associated with the operating system 146, active application or active onscreen element. For example, when viewing an email, the context-sensitive menu may contain commands relating to email messaging such as reply, forward, delete, etc. Similar to when used to invoke the virtual keyboard 320, the method 600 may be advantageous when used to show and hide a context-sensitive menu in that it avoids interacting with a mechanical key or onscreen element displayed on a touch-sensitive display 118 to trigger the display of the context-sensitive menu.

In some embodiments, the processor 102 may be configured to detect different types of motion gestures to display different user interface elements. For example, flick gestures may be used to show and hide the virtual keyboard 320 whereas cycle gestures may be used to show and hide the context-sensitive menu. For example, a left-right cycle gesture may be used to show the context-sensitive menu and a right-left cycle gesture may be used to hide the context-sensitive menu, or vice versa.

The processor 102 may be configured to detect motion only when a predetermined condition exists. This may reduce power consumption and may reduce inadvertent gestures, for example caused by movement while in a user's pocket or bag, from triggering a response by the portable electronic device 100. This may also increase the accuracy of identifying motion gestures since the predetermined condition provides an indication that the gesture is intended if the predetermined condition exists. In such cases, the processor 102 needs only to match the detected motion to available gestures in the specified context or state of the portable electronic device 100 rather than determining whether the motion detected by the portable electronic device 100 is a known motion gesture. The predetermined condition may be depression of a designated button 120 (e.g., a press and hold of the designated button 120), depression of the depressible optical joystick, display of a designated user interface screen, selection of a designated user interface element such as a text input field, or other suitable predetermined condition.

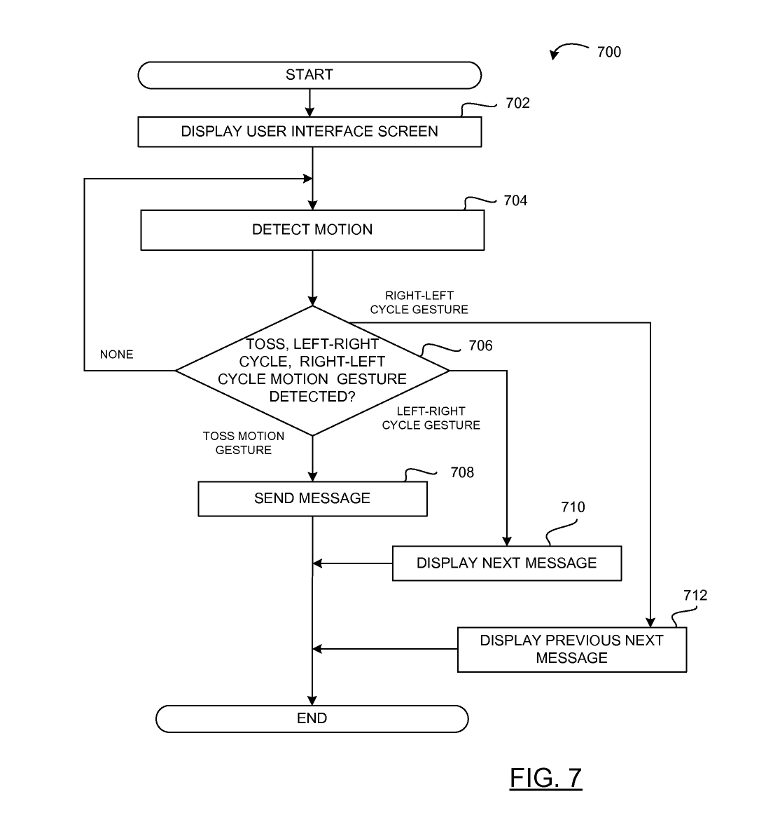

A flowchart illustrating one example embodiment of a method 700 of interacting with a portable electronic device using a touch-sensitive display in accordance with one example embodiment of the present disclosure is shown in FIG. 7. The method 700 may be carried out by software executed, for example, by the processor 102. Coding of software for carrying out such a method 700 is within the scope of a person of ordinary skill in the art provided the present disclosure. The method 700 may contain additional or fewer processes than shown and/or described, and may be performed in a different order. Computer-readable code executable by the processor 102 to perform the method 700 may be stored in a computer-readable medium such as the memory 110.

First, a messaging application is started and a user interface screen for the messaging application is displayed on the touch-sensitive display 118 of the portable electronic device 100, typically in response to user input (702). From a default user interface screen of the messaging application, such as an inbox, the user can navigate to other user interface screens such as a message composition user interface screen for composing an electronic message, or a messaging viewing user interface screen in which a received message is displayed on the touch-sensitive display 118.

The messaging application may be, but is not limited to, an email messaging application for composing and sending email messages, an SMS (Short Message Service) messaging application for composing and sending SMS text messages, a Multimedia Messaging Service (MMS) messaging application for composing and sending MMS text messages, an instant messaging (IM) application for composing and sending IM messages, a peer-to-peer or device-to-device messaging application for composing and sending peer-to-peer messages, or a personal information manager (PIM) for composing and sending a number of different types of electronic messages.

Next, the portable electronic device 100 monitors for and detects motion of the portable electronic device 100 (704). Next, the portable electronic device 100 determines whether detected motion matches a toss gesture, a left-right cycle gesture, or a right-left cycle gesture (decision block 706) based on patterns of motion recognized by the portable electronic device 100. The portable electronic device 100 has motion analyzing unit which analyses the acceleration measurements in terms of factors such as amplitude/magnitude over time, frequency, or other factors to determine whether detect motion matches a known motion gesture such as the toss gesture, left-right cycle gesture and right-left cycle gesture. As noted above, a toss gesture comprises a rotation around an axis normal to a plane of the portable electronic device 100 (e.g., normal to a plane of a surface of the touch-sensitive display 118).

When a toss gesture is detected, any electronic message under composition is sent using the communication subsystem 104 over the wireless network 150 when at least one address for the electronic message is defined (708). When at least one address for the electronic message is not defined, a prompt to enter at least one address for the electronic message may be provided after which the electronic message will be sent. A notification that electronic message has been sent may be displayed on the display 112 to inform the user. When an electronic message is not under composition, the portable electronic device 100 does not monitor for toss gestures and any toss gesture which is performed is not detected. Alternatively, the portable electronic device 100 may monitor for and detect toss gestures but ignores any toss gesture when an electronic message is not under composition.

When the left-right cycle gesture is detected, the electronic messaging application causes a next message in an inbox, message folder or message list of the electronic messaging application to be displayed (710). The next message is determined relative to a currently selected message, typically in chronological order from older to newer messages. The currently selected message may be indicated in the inbox, message folder or message list of the electronic messaging application displayed on the display 112, for example, by highlighting or focusing the message in the inbox, message folder or message list or other suitable method of visual indication. Highlighting or focusing the currently selected message causes the appearance of the corresponding message in the inbox, message folder or message list to be changed from a first visual state to a second visual state different from the first visual state. Changing the appearance of the message in the inbox, message folder or message list, in at least some embodiments, may comprise changing a colour of a background or field of the message entry in the inbox, message folder or message list, the text of the message entry in the inbox, message folder or message list, or both. The currently selected message may be displayed on the display 112. Alternatively, the currently selected message may not be shown or otherwise indicated on the display 112.

When the right-left cycle gesture is detected, the electronic messaging application causes a previous message in the inbox, message folder or message list of the electronic messaging application to be displayed (712). The previous message is determined relative to a currently selected message, typically in chronological order from older to newer messages.

When an electronic message is not selected, the portable electronic device 100 does not monitor for left-right cycle gestures or right-left cycle gestures and any left-right cycle gesture or right-left cycle gesture which is performed is not detected is ignored. Alternatively, the portable electronic device 100 may monitor for and detect left-right cycle gestures and right-left cycle gestures but ignores any detected when an electronic message is not selected. Alternatively, the next message or previous message may be determined based on a default message such as the most recently received message. In some embodiments, when an electronic message is being composed and a message composition user interface screen is displayed on the touch-sensitive display 118 when a left-right cycle gesture or right-left cycle gesture is detected, the electronic message under composed may be automatically saved as a draft message before displaying the next message or previous message.

When the detected motion does not match the toss gesture, left-right cycle gesture or right-left cycle gesture, the motion is ignored. Alternatively, if the detected motion matches another motion gesture recognized by the portable electronic device 100, the command or action associated with that other motion gesture may be performed, depending on the embodiment.

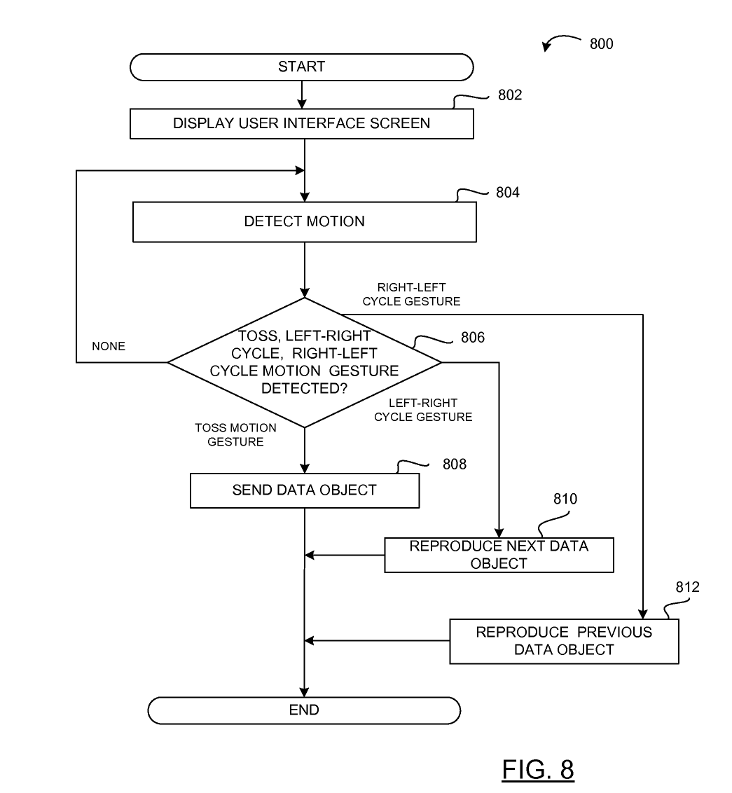

A flowchart illustrating one example embodiment of a method 800 of interacting with a portable electronic device using a touch-sensitive display in accordance with one example embodiment of the present disclosure is shown in FIG. 8. The method 800 may be carried out by software executed, for example, by the processor 102. Coding of software for carrying out such a method 800 is within the scope of a person of ordinary skill in the art provided the present disclosure. The method 800 may contain additional or fewer processes than shown and/or described, and may be performed in a different order. Computer-readable code executable by the processor 102 to perform the method 800 may be stored in a computer-readable medium such as the memory 110.

First, a media player application is started and a user interface screen for the media player application is displayed on the touch-sensitive display 118 of the portable electronic device 100, typically in response to user input (802). Next, the portable electronic device 100 monitors for and detects motion of the portable electronic device 100 (804). Next, the portable electronic device 100 determines whether detected motion matches a toss gesture, a left-right cycle gesture, or a right-left cycle gesture (decision block 806) based on patterns of motion recognized by the portable electronic device 100. The portable electronic device 100 has motion analyzing unit which analyses the acceleration measurements in terms of factors such as amplitude/magnitude over time, frequency, or other factors to determine whether detect motion matches a known motion gesture such as the toss gesture, left-right cycle gesture and right-left cycle gesture.

When a toss gesture is detected, a selected data object such as a digital picture or graphic object, video object, or audio object (e.g., song) is sent to a second electronic device operably coupled to the portable electronic device 100 (808). When a destination is not defined, a prompt to enter a destination for the selected data object may be provided after which the selected data object will be sent. A data object is not currently selected, a prompt to select a data object may be provided after which the selected data object will be sent. The second electronic device may be a computer, smartphone, digital picture frame, portable media player, portable gaming device, portable navigation device, or any other electronic device. For security reasons, the second electronic device is typically an electronic device with which the portable electronic device 100 has previously paired. Pairing allows the devices to connect and communicate with each other, typically without user intervention.

When the data object is an audio object or video object, sending the data object may comprise streaming the audio (e.g., song/track) defined by the audio object or streaming the video defined by the video object to the second electronic device.

The portable electronic device 100 may be operably coupled to the second electronic device using a short-range communications protocol supported by the short-range communications subsystem 132 including, but not limited to, Universal Serial Bus (USB), Wi-Fi®, Bluetooth®, UltraWideband (UWB), an Infrared Data Association (IrDA), Z-Wave or ZigBee wireless network or other suitable wireless local area network (WLAN) protocol. When the portable electronic device 100 is not coupled to an electronic device, a prompt to connect to an electronic device may be provided after which the selected data object will be sent.

Alternatively, the selected data object may be sent to a recipient using the communication subsystem 104 over the wireless network 150 when a destination (e.g., blog, webpage, RSS feed, etc.) is defined. When a destination is not defined, a prompt to enter a destination for the selected data object may be provided after which the selected data object will be sent. A notification that selected data object has been sent may be displayed on the display 112 to inform the user.

When the left-right cycle gesture is detected, the media player application causes content of a next data object of the same data type in a datastore of the media player application, such as a database of data objects of the same type stored in the memory 110, to be reproduced. When the data object is a digital picture or graphic object, reproducing comprises displaying the digital picture or graphic defined by the digital picture or graphic object on the display 112. When the data object is a video object, reproducing comprises playing the video defined by the video object on the display 112 and speaker 128 or routing an electrical acoustic audio signal to the data port 126 for output to headphones or other external speaker. When the data object is an audio object, reproducing comprises playing the audio (e.g., song or track) defined by the audio object using the speaker 128 or routing an electrical acoustic audio signal to the data port 126 for output to headphones or other external speaker.

The next data object is determined relative to a currently selected data object, for example, in alphabetical order or chronological order from older to newer. The currently selected data object may appear as an entry in a playlist of the media player application. The currently selected data object may be indicated in a displayed playlist using highlighting or focusing the corresponding entry in the displayed playlist or other suitable method of visual indication. Highlighting or focusing an entry in the displayed playlist causes the appearance of the corresponding entry in the displayed playlist to be changed from a first visual state to a second visual state different from the first visual state. Changing the appearance of an entry in the displayed playlist, in at least some embodiments, may comprise changing a colour of a background or field of the entry in the displayed playlist, the text of the entry in the displayed playlist, or both. Alternatively, the currently selected data object may not be shown or otherwise indicated on the display 112.

The currently selected data object may be in reproduction, for example, when the currently selected data object is a digital picture or graphic object, the currently selected digital picture or graphic may be being displayed on the display 112. Similarly, when the currently selected data object is an audio object (e.g., song or track), the currently selected song or track may be being played, for example, with the speaker 128. When the currently selected data object is a video object, the currently selected video object may be being played on the display 112 and speaker 128.

When the right-left cycle gesture is detected, the media player application causes content of a previous data object of the same data type in a datastore of the media player application, such as a database of data objects of the same type stored in the memory 110, to be reproduced. When the data object is a digital picture or graphic object, reproducing comprises displaying the digital picture or graphic defined by the digital picture or graphic object on the display 112. When the data object is a video object, reproducing comprises playing the video defined by the video object on the display 112 and speaker 128 or routing an electrical acoustic audio signal to the data port 126 for output to headphones or other external speaker. When the data object is an audio object, reproducing comprises playing the audio (e.g., song/track) defined by the audio object using the speaker 128 or routing an electrical acoustic audio signal to the data port 126 for output to headphones or other external speaker.

The previous data object is determined relative to a currently selected data object, for example, in alphabetical order or chronological order from older to newer.

When a data object is not selected, the portable electronic device 100 does not monitor for left-right cycle gestures or right-left cycle gestures and any left-right cycle gesture or right-left cycle gesture which is performed is not detected is ignored. Alternatively, the portable electronic device 100 may monitor for and detect left-right cycle gestures and right-left cycle gestures but ignores any detected when a data object is not selected. Alternatively, the next or previous data object may be determined based on a default data object such as the last accessed data object of the given type in a media folder, database, or playlist, or the newest data object of the given type.

When the detected motion does not match the toss gesture, left-right cycle gesture or right-left cycle gesture, the motion is ignored. Alternatively, if the detected motion matches another motion gesture recognized by the portable electronic device 100, the command or action associated with that other motion gesture may be performed, depending on the embodiment.

In other embodiments, the toss gesture, left-right cycle gesture and right-left cycle gestures described above could be applied to calendars in a calendar application, which could be part of a PIM on the portable electronic device 100. Detection of a left-right cycle gesture by the portable electronic device 100 may cause a previous view of a current view type to be displayed. Detection of a right-left cycle gesture by the portable electronic device 100 may cause a next view of a current view type to be displayed. A calendar application typically has several view types including, but not limited to, an event view, an agenda view, a month view, a week view, a day view, etc. The event view shows event details about a particular event. The agenda view shows event details about events for the current day. The month view shows the current month including any events in the current month. The week view shows the current week including any events in the current week. The day view shows the current day including any events in the current day. Detection of a toss gesture by the portable electronic device 100 may invite a second electronic device, such a paired device, to an appointment which is described in an event view displayed on the display 112, or selected (e.g., highlighted) event in an agenda view, month view, week view, day view or other view displayed on the display 112. The operation of the calendar application in connection with the toss gesture, left-right cycle gesture and right-left cycle gestures and the above-described commands would operate generally similar to the method 800 except for the different functionality described above.

In other embodiments, the toss gesture, left-right cycle gesture and right-left cycle gestures described above could be applied to the Web browser application. Detection of a left-right cycle gesture by the portable electronic device 100 may cause a back command to be performed by the Web browser. Detection of a right-left cycle gesture by the portable electronic device 100 may cause a forward command to be performed by the Web browser. Detection of a toss gesture (or shake gesture) by the portable electronic device 100 may cause creation of a favourite for the current Uniform Resource Locator (URL), bookmarking of streamed media, or downloading content or queuing content for download depending on the context. The context-sensitive factors for selecting the context-sensitive action may depend on several factors, such as whether streamed content is available or selected (e.g., highlighted) in the content (e.g., Web page) displayed by the Web browser on the display 112, whether downloadable content is available or selected (e.g., highlighted) in the content (e.g., Web page) displayed by the Web browser on the display 112. For example, if nothing is selected when a toss away gesture is detected, the portable electronic device 100 may send the page URL to a paired electronic device device and may bookmark the page if nothing is selected when a toss towards gesture is detected. However, selecting an object (e.g., touching an object on the page with a touch-sensitive display 118) may send, bookmark or download that object.

In other embodiments, the toss gesture, left-right cycle gesture and right-left cycle gestures described above could be applied to cycling between sources of notification. A notification queue is provided in which all new notifications, regardless of type, are queued by as on a notification time stamp describing when the notification was generated or received. The notification queue may be agnostic with respect to the source of notification or notification type. The notification queue may be ordered newest to oldest or oldest to newest, depending on device settings and user preferences. The order of the notification queue may be a configurable.

Notification cycling, in some embodiments, may only be supported when a messaging application or PIM is the active application 148 on the portable electronic device 100, i.e. the foreground application. To be supported when other application 138 are active, the gestures used in notification cycling should be used by the active application 148 to avoid conflict. Alternatively, the gestures used in notification cycling may be rendered temporality unavailable/unsupported for a threshold duration from the receipt of the notification (e.g., within 5 seconds of the receipt of a notification). This allows the gestural control of the notification cycling to override the gestural control of the active application 148 to prevent conflicts.

Detection of a right-left cycle gesture by the portable electronic device 100 causes the newest notification or the source of the newest notification, such as the newest event or electronic message, to be displayed on the display 112. It will be appreciated that a notification can act as a source in some instances, for example, when the notification is a reminder or alarm. When the source of the notification is displayed, it is removed from the notification queue. When no notifications are in the notification queue, a right-left cycle gesture which is detected by the portable electronic device 100 when no unread electronic message exists is ignored. When the notification queue is limited to new message notifications.

Detection of a further right-left cycle gesture by the portable electronic device 100 when the newest notification or the source of the newest notification is displayed on the display causes the next newest electronic message to be displayed on the display 112. Detection of yet a further right-left cycle gesture by the portable electronic device 100 when the notification or the source of the notification is displayed on the display 112 causes the next newest electronic message to be displayed on the display 112, and so on.

Detection of a left-right cycle gesture by the portable electronic device 100 when the notification or the source of the notification is displayed on the display 112 causes the previously displayed user interface screen, i.e. the previously displayed message or inbox (if no message was previously displayed) to be displayed on the display 112. The re-display/return to the previously displayed user interface screen acts as a reset for a notification cycling gesture.

For example, if a user is composing an email message and a notification of a new instant message occurs (e.g., vibration informing the user of the new IM), performing a right-left cycle gesture cause the new instant message (e.g., within an IM thread) to be displayed on the display 112. Performing a left-right cycle causes the email message which the user was composing to be displayed on the display 112. Alternatively, if a user is instant messaging and a notification of a new RSS (Really Simple Syndication) article in Web feeds occurs (e.g., vibration) following by a notification of a new instant message occurs (e.g., vibration), performing a right-left cycle gesture causes the new IM message to be displayed on the display 112. Performing a further right-left cycle gesture causes the new RSS article be displayed on the display 112. Performing a left-right cycle causes the conversation in which the user was working to be displayed on the display 112. If the notification queue is works oldest to newest rather than newest to oldest, performing the first right-left cycle gesture would cause the new RSS article to be displayed on the display 112 and performing a further right-left cycle gesture would cause the new IM message to be displayed on the display 112.

In other embodiments, the notification queue may be limited to notifications of a particular type, for example notifications of new messages of a particular type. The toss gesture, left-right cycle gesture and right-left cycle gestures described above may be used to cycle through messages of the same type. A shake gesture, other gesture or input (e.g. depressing of a designated button or key, or touching of an onscreen element) may be used to change the particular type of notification, e.g. particular type of message being cycled.

In some embodiments, detection of a shaking gesture when may cause the portable electronic device 100 to switch applications 148 among currently active applications. In some embodiments, the portable electronic device 100 may monitor for and detect the shaking gesture when an application 148 is displayed on the display 112, i.e. in the foreground. In other embodiments, the portable electronic device 100 may only monitor for and detect the shaking gesture when an application 148 is not displayed, i.e., when the home screen is displayed on the display or an application 148 is otherwise not in the foreground. This allows the shaking gesture to be used by the application 148 for other purposes.

There are numerous possible permutations of acceleration gesture (motion gesture) and command combinations; however, not all acceleration gesture and command combinations are procedural efficient to implement or intuitive for a user. The present disclosure describes a number of acceleration gesture and command combinations which can be implemented in a relatively straightforward manner within a GUI without becoming awkward in terms of processing or user experience, and without conflicting with other gestural command inputs, touch command inputs and or other command inputs. These acceleration gesture and command combinations described herein are believed to provide a more intuitive user interface for providing the described functionality with less processing complexity than menu-driven or button/key-driven alternatives.

While the present disclosure is described primarily in terms of methods, the present disclosure is also directed to a portable electronic device configured to perform at least part of the methods. The portable electronic device may be configured using hardware modules, software modules, a combination of hardware and software modules, or any other suitable manner. The present disclosure is also directed to a pre-recorded storage device or computer-readable medium having computer-readable code stored thereon, the computer-readable code being executable by at least one processor of the portable electronic device for performing at least parts of the described methods.

The present disclosure may be embodied in other specific forms without departing from its spirit or essential characteristics. The described embodiments are to be considered in all respects as being only illustrative and not restrictive. The present disclosure intends to cover and embrace all suitable changes in technology. The scope of the present disclosure is, therefore, described by the appended claims rather than by the foregoing description. All changes that come within the meaning and range of equivalency of the claims are intended to be embraced within their scope.

1. A method of interacting with a portable electronic device, the method comprising:
detecting motion of the portable electronic device;
determining whether detected motion matches a first motion gesture or second motion gesture;
when the first motion gesture is detected, showing a designated user interface element in a user interface screen displayed on a touch-sensitive display of the portable electronic device; and
when the second motion gesture is detected, hiding the designated user interface element from the user interface screen displayed on the touch-sensitive display of the portable electronic device.

2. The method of claim 1, wherein the first motion gesture and second motion gesture are directional motion gestures having a primary direction of motion, wherein the primary direction of motion of the first motion gesture and second motion are oriented in generally opposite directions to each other.

3. The method of claim 1, wherein the second motion gesture is a reversed motion sequence of the first motion gesture.

4. The method of claim 1, wherein the first motion gesture comprises an up-down motion and the second motion gesture comprises a down-up motion.

5. The method of claim 1, wherein the first motion gesture comprises a down-up motion and the second motion gesture comprises an up-down motion.

6. The method of claim 1, wherein the first motion comprises a left-right motion and the second motion gesture comprises a right-left motion.

7. The method of claim 1, wherein the designated user interface element is a virtual keyboard.

8. The method of claim 1, wherein the designated user interface element is a context-sensitive menu.

9. The method of claim 1, wherein the first motion gesture is a left-right gesture and the second motion gesture is a right-left gesture, and the designated user interface element is a context-sensitive menu.

10. The method of claim 1, wherein the first motion gesture is an up-down flick gesture and the second motion gesture is a down-up flick gesture, and the designated user interface element is a virtual keyboard.

11. The method of claim 10, further comprising:
determining whether detected motion matches a left-right gesture or right-left gesture;
when the left-right gesture is detected, showing a context-sensitive menu in a user interface screen displayed on a touch-sensitive display of the portable electronic device; and
when the right-left gesture is detected, hiding the context-sensitive menu in the user interface screen displayed on the touch-sensitive display of the portable electronic device.

12. The method of claim 1, wherein the designated user interface element is shown when not already displayed on the touch-sensitive display of the portable electronic device, and the designated user interface element is hidden when displayed on the touch-sensitive display of the portable electronic device.

13. A method of interacting with a portable electronic device, the method comprising:
detecting motion of the portable electronic device;
determining whether detected motion matches known motion gestures;
when a toss gesture is detected, sending an electronic message under composition to at least one address specified by the electronic message under composition;
when a left-right gesture is detected, displaying a next electronic message in an inbox or message list of an electronic messaging application; and
when a right-left gesture is detected, displaying a previous electronic message in an inbox or message list of the electronic messaging application.

14. A method of interacting with a portable electronic device, the method comprising:
detecting motion of the portable electronic device;
determining whether detected motion matches known motion gestures;
when a toss gesture is detected, sending a data object to a second electronic device using a short-range communication protocol;
when a left-right gesture is detected, reproducing content of a next data object in a datastore of a media player application; and
when a right-left gesture is detected, reproducing content of a previous next data object in a datastore of a media player application.

15. A portable electronic device, comprising:
a housing;
a processor received within the housing;
a touch-sensitive display coupled to the processor and having a touch-sensitive overlay exposed by the housing; and
an accelerometer display coupled to the processor;
wherein the processor is configured for: detecting motion of the portable electronic device; determining whether detected motion matches a first motion gesture or second motion gesture; when the first motion gesture is detected, causing a designated user interface element to be shown in a user interface screen displayed on a touch-sensitive display of the portable electronic device; and when the second motion gesture is detected, causing the designated user interface element to be hidden from the user interface screen displayed on the touch-sensitive display of the portable electronic device.

16. The portable electronic device of claim 15, wherein the first motion gesture and second motion gesture are directional motion gestures having a primary direction of motion, wherein the primary direction of motion of the first motion gesture and second motion are oriented in generally opposite directions to each other.

17. The portable electronic device of claim 15, wherein the second motion gesture is a reversed motion sequence of the first motion gesture.

18. The portable electronic device of claim 15, wherein the first motion gesture is a left-right gesture and the second motion gesture is a right-left gesture, and the designated user interface element is a context-sensitive menu.

19. The portable electronic device of claim 15, wherein the first motion gesture is an up-down flick gesture and the second motion gesture is a down-up flick gesture, and the designated user interface element is a virtual keyboard.

20. The portable electronic device of claim 15, wherein the processor is configured for: determining whether detected motion matches a left-right gesture or right-left gesture; when the left-right gesture is detected, causing a context-sensitive menu to be shown in a user interface screen displayed on a touch-sensitive display of the portable electronic device; and when the right-left gesture is detected, causing the context-sensitive menu to be hidden from the user interface screen displayed on the touch-sensitive display of the portable electronic device.
